(19) United States
(12) Patent Application Publication
(10) Pub. No.: US 2004/0150717 A1
(43) Pub. Date: Aug. 5, 2004

(54) Digital in-car video surveillance system

(76) Inventors: Warren S. Page, Parsons, KS (US); James K. Creviston, Chanute, KS (US); David W. Teeter, Overland Park, KS (US); Roger A. Adwell, Chanute, KS (US); Thomas E. Mitchell, Chanute, KS (US)

Correspondence Address: CHASE & YAKIMO, L.C., 4400 COLLEGE BOULEVARD, SUITE 130, OVERLAND PARK, KS, 66211

(21) Appl. No.: 10/670,690

(22) Filed: Sep. 25, 2003

Related U.S. Application Data
(60) Provisional application No. 60/441,631, filed on Jan. 21, 2003.

(51) Int. Cl. H04N 7/18

(52) U.S. Cl. 348/148; 348/143

(57) ABSTRACT

A digital video surveillance system for a law enforcement vehicle comprises a video camera mounted on the law enforcement vehicle and positioned to view an incident. A memory buffer records video signals from the video camera. A controller generates record and playback signals to record and to display the video signals. A digital video recorder is responsive to the record signal to record the video signals from the memory buffer on an optical medium and to the playback signal to reproduce video signals recorded on the optical medium. A vault encloses the digital video recorder. A battery provides backup power to the digital video surveillance system. The optical medium may be a DVD disk. A watermark may be included with the digital recording.

### BACKGROUND OF THE INVENTION

This invention is directed to a video surveillance system, and in particular to a video surveillance system mounted in a law enforcement vehicle for producing a permanent digital evidentiary record, on a multi-media disk, of a traffic stop or other event and incidents occurring after the suspect's vehicle has been stopped.

In law enforcement, a reliable witness that is incapable of perjury is needed to substantiate the actions taken by the law enforcement officer and to protect the officer against false allegations by the persons involved in the incident. An excellent witness of this type is a video recording of the incident, now widely used in traffic stops and criminal interdictions, which can be reviewed after the incident and archived. By recording the incident first-hand as it actually happened, video recordings eliminate conflicting individual interpretations of the incident and facilitate effective and efficient law enforcement.

Vehicle mounted video cameras to make video records of an incident or scene external to the law enforcement vehicle are well known in the art. For example, U.S. Pat. No. 4,949,186 to Peterson discloses a vehicle mounted system in which a video cassette recorder is housed in a vault located in the trunk of a patrol car. U.S. Pat. No. 5,677,979 to Squicciarini et al discloses a video surveillance system which integrates the outputs of a video camera, a radar unit, a wireless microphone, a remote control and a wireless microphone to produce a comprehensive video recording of an incident from its beginning to the end. This system also uses a video cassette recorder to capture the incident on videotape. However, VHS and digital video tapes are bulky, requiring considerable space for storage, are susceptible to damage, and degrade over time. Additionally, the data on tapes may only be accessed sequentially.

(Docket 3000)

### SUMMARY OF THE INVENTION

The digital video surveillance system of the present invention includes a video server in a law enforcement vehicle which allows recording to various digital optical media including DVD RAM disks. Recording to these media in a moving vehicle and in all-weather conditions is possible by shock-mounting the drives and providing environmental assistance for heating and cooling a lockable protective enclosure in which the drives are encased. This system includes a memory buffer that is recording at all times. When the recorder is activated, the memory buffer contents, including video and audio, will be recorded onto the DVD RAM disk. This ensures that the activity occurring just prior to the activation of the system is recorded as well. The system further provides a method to capture or receive snapshots and output them to or receive them from a wireless transmitter such as a cellular modem for missing persons or suspect identification, for example. Forward-facing and interior cameras are mounted inside an overhead console to reduce the obstruction to the driver and to eliminate the chance of interfering with a passenger side air bag.

Other advantages of this invention will become apparent from the following description taken in connection with the accompanying drawings, wherein is set forth by way of illustration and example, a preferred embodiment of the present invention.

### BRIEF DESCRIPTION OF THE DRAWINGS

FIG. 1 is a block diagram showing the basic components of the digital video surveillance system;

FIG. 2 is a functional block diagram of the hardware components of the digital video surveillance system;

FIG. 3 is a software flow chart for the vault logic controller;

FIG. 4 is a software flow chart for the get/put control data routine;

FIG. 5 is a software flow chart for the keyboard interrupt service routine;

FIG. 6 is a software flow chart for the analog-to-digital interrupt service routine;

FIGS. 7a-7b are a software flow chart for the serial communications interface receive interrupt service routine;

FIG. 8 is a software flow chart for the serial communications interface transmit interrupt service routine;

FIG. 9 is a software flow chart for the control head logic main loop;

FIG. 10 is a software flow chart for the vault receive routine;

FIG. 11 is a software flow chart for the display update routine;

FIG. 12 is a software flow chart for the keyboard interrupt routine;

FIG. 13 is a software flow chart for the transmit setup routine;

FIG. 14 is a software flow chart for the in-circuit programming routine;

FIG. 15 is a software flow chart for the transmit interrupt routine;

FIG. 16 is a software flow chart for the timer interrupt routine;

FIG. 17 is a software flow chart for the radar receive routine; and

FIG. 18 is a software flow chart for the process radar routine.

FIG. 19 is an illustration of the main menu display.

FIG. 20 is an illustration of the setup submenu display.

FIG. 21 is an illustration of the display submenu display.

FIG. 22 is an illustration of the set time/date submenu display.

FIG. 23 is an illustration of the set user information submenu display.

FIG. 24 is an illustration of the system settings submenu display.

FIG. 25 is an illustration of the set zoom values submenu display.

FIG. 26 is an illustration of the focus submenu display.

FIG. 27 is an illustration of the zoom submenu display.

FIG. 28 is an illustration of the play submenu display.

### DETAILED DESCRIPTION

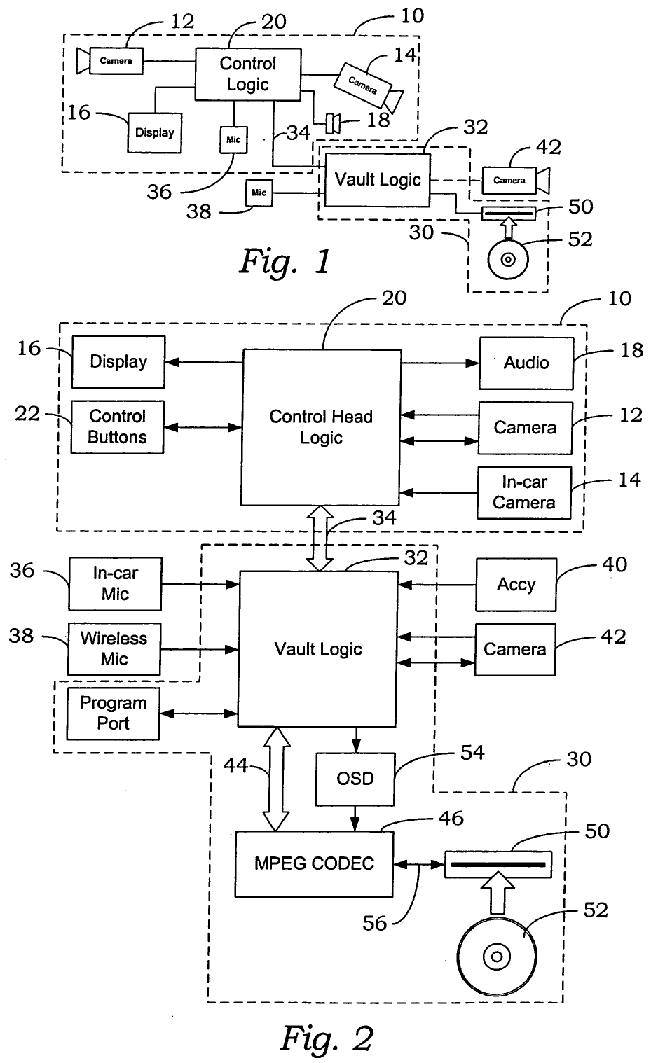

FIG. 1 is a block diagram showing the basic components of the digital video surveillance system. The system is preferably mounted in a law enforcement vehicle, such as a patrol car. An overhead console 10 is mounted inside the passenger compartment of the vehicle above the rearview mirror. The overhead console 10 includes a color video camera 12, which is pointed in a forward direction to capture images through the windshield. The color video camera 12 may be mounted within the overhead console 10 above the vehicle's internal rearview mirror with a view through the windshield so as not to obstruct the forward view of the driver of a passenger of the vehicle. The video camera 12 includes a wide-angle motorized zoom lens, which allows the operator to easily adjust from a wide angle to a telephoto position and a motorized auto iris, which adjusts the light level from day to night and in varying light conditions to increase the operating light range of the video camera.

A second video camera 14 may be mounted inside overhead console 10 and may be pointed in a rearward direction to view the interior and occupants of the vehicle. The video captured by cameras 12 and 14 may be displayed on monitor 16 and the audio output through speaker 18.

Monitor 16 is preferably a 3.5″ color LCD monitor. The monitor 16 is designed to monitor video and audio signals, and is used to focus and adjust the camera 12, and review recorded segments. The monitor 16 is not required for the rest of the system to operate, and can be turned off if it is distracting to the operator. Information displayed on the monitor 16 may include time, date, emergency lights indicator, siren indicator (where applicable), brake indicator (where applicable), microphone indicator, additional identifier (60 spaces available) and backlight compensation indicator, for example. In addition, optional interfaces to compatible Kustom Signals radar units and GPS modules may be available. When these optional features are used, radar speed data and/or patrol location coordinates may be recorded on the DVD RAM disk 52 and displayed on the monitor 16. Live video from the camera 12 or 14 may be viewed through the monitor 16 whether or not the system is recording.

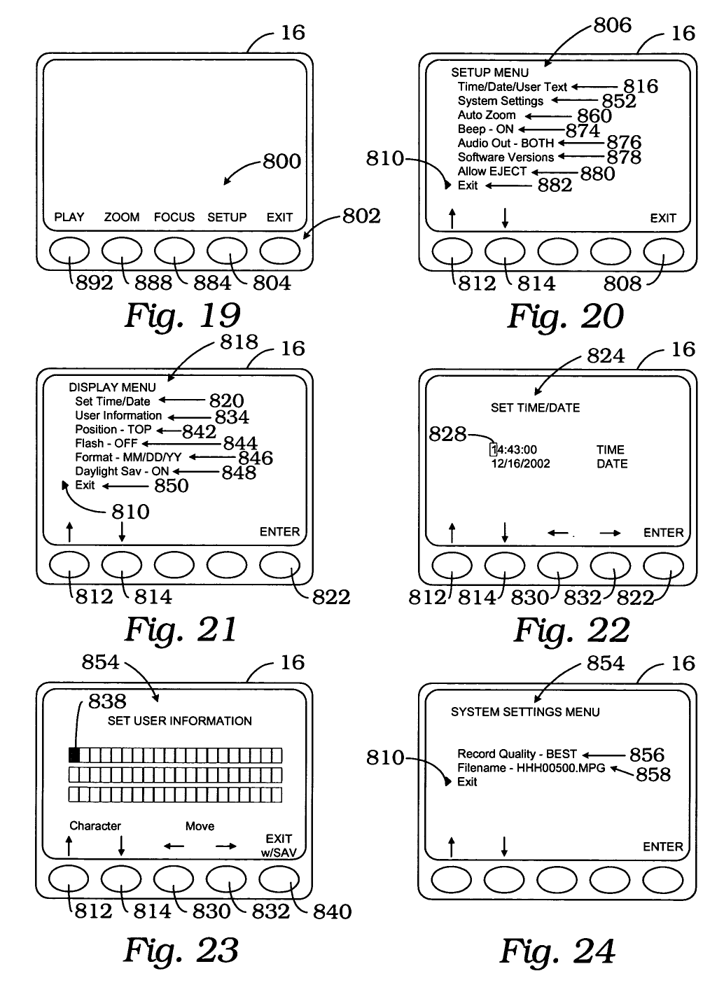

The monitor also includes five buttons at the bottom of the screen (see FIGS. 19-28), which have functions dynamically assigned depending on the menu or display selection. In normal operation, these buttons may be assigned to the functions PLAY, FOCUS, ZOOM, SETUP and EXIT, for example. All of these buttons activate sub-menus within that category, except EXIT, which allows the user to get out of the menu mode, and hides the menu selection bar. The PLAY button plays the last video file recorded, and activates a submenu for reviewing previously recorded video. The FOCUS button is for manual or automatic focus, and for the activation of the Backlight function on the camera 12. The ZOOM button allows the user to manually operate the camera 12 zoom functions. The SETUP button selects the main menu screen. When the SETUP button is depressed, the five buttons are reassigned to serve the main SETUP menu screen. When one of the sub menus is selected, the five buttons are re-assigned a function according to that sub menu.

The software menus and associated submenus (see FIGS. 19-28), which allow the operator to select or change system options and controls, are similar to state of the art systems in present use. Items that may be included on the set-up menu are time/date, display options, camera options, record length, beep control and audio-out control. The time/date submenu includes setting the time and date, the time/date position on the recording and screen (top or bottom), flash preference (on or off) and date format. The display submenu includes settings for an identification generator such as badge number, car number, precinct number, etc., for example. The camera submenu may include settings for auto zoom telephoto, auto zoom wide, and default settings. These menus are accessed using software controlled buttons located below the display screen 16 (see FIGS. 19-28).

Referring to FIGS. 1 and 2, the above-described components (camera 12, camera 14, display or monitor 16 and speaker 18) are all controlled through the control head logic 20 by inputs from control panel 22. Control panel or center 22 includes switches, push buttons and other hardware controls to control power to the system, the record and playback function of recorder 50, and a time-left display (not shown) to display recording time left on the DVD RAM disk 52. Control head logic 20 includes an 8-bit microprocessor such as the MC68HC908GP32CFB microprocessor available from Motorola.

The Control Center 22 allows the officer to manually turn the unit ON and OFF and START or STOP the recorder 50 at his or her discretion. A solid LED on the Record button (not shown) and a blinking colon in the time display (not shown) indicates that the system is recording. The recorder 50 may be activated with the emergency lights, siren (if applicable) or microphone, and is turned off at the Control Center 22. Turning off the lights, siren, or microphone does not stop the recorder 50. This feature ensures that once activated, the recorder 50 will continue recording even if the light bar or siren malfunctions, or if there is interference on the microphone's 38 frequency. When the emergency lights, siren, or microphone are used to start the recorder 50, an “L”, “S”, or “M” will appear recorded on the DVD RAM disk 52 near the time display.

The time left on disk is displayed in hours and minutes. When approximately ten minutes of disk space for recording is left, the display will blink and the Control Center 22 beeps once, and continues to beep once per minute. When only five minutes are left, the display blinks faster. When the disk 52 reaches its end, the display stops blinking and reads “END”. If no disk 52 in the recorder 50, the time left display shows three horizontal dashes and the recorder 50 may not be activated until a disk 52 is inserted.

The Low Voltage LED (not shown) on the panel 22 lights up whenever the voltage input to the system drops below 10.5 volts. As the voltage drops, the picture quality may deteriorate. Low voltages may also place the system in its STOP mode and cause the Control Center 22 to alert the operator.

The vault or system enclosure generally indicated by reference numeral 30 includes vault logic 32 which is connected to the control head logic 20 by a vault cable 34. The vault logic receives data from the in-car microphone 36, a wireless microphone 38 worn by a police officer, accessories 40 such as the emergency lights, brakes, or radar, and an optional camera 42 which may be directed out of the rear of the vehicle. Video and audio data is transferred over an interface 44 to the MPEG (Moving Pictures Expert Group) CODEC (Coder-decoder) logic or video server 46, which compresses or decompresses the data in real time for storage or retrieval from a digital video recordable media disk drive 50 and DVD RAM disk 52. User entered data and/or data from accessories 40 are processed by an on screen display processor 54 to be combined and recorded with the video data. The vault logic 32 includes an 8-bit vault logic microprocessor such as the MC68HC908GP32CFB microprocessor available from Motorola.

The vault logic 32 includes a connector board, a vertical board and a vault or tray logic board as well as a receiver board for wireless audio reception. The DVD RAM drive 50 is connected through an IDE interface 56 to the video server 46, which controls all the functions of the DVD RAM drive 50. The connector board includes the vault cable connector from the overhead console and connectors for another video camera such as a video camera directed out of the rear of the vehicle 42, the in-car microphone 36, the receiver input from the wireless microphone 38, and a connector for the system trigger 40. The vertical board connects the connector board to the tray logic board. The vertical board also provides a connection between the video server 46 and the tray logic board. The tray logic board receives commands from the overhead console logic board through the user interface.

The video server board 46 includes from 4 to 512 megabytes of RAM, which is used as a history buffer. The system constantly stores information from the cameras and audio input in the RAM on the video server board 46 which stores seventeen to thirty seconds of video history for a 4 Mb history buffer and up to three minutes or more for a 512 Mb history buffer depending on the resolution of the video recorded, for example. The history buffer is a circular FIFO buffer which allows events to be recorded that occurred prior to the system receiving the record command. When the record function is activated, the history buffer prior to activation is transferred to the DVD RAM drive to record the incident up to the point when the record signal was received. Data in the history buffer is transferred to the DVD RAM disk at a data rate of approximately 2.7 Mb per second. If the history buffer is full when recording starts, this transfer occurs in approximately three minutes, for a 512 Mb history buffer. Thereafter, video and audio data is collected in the history buffer before being transferred to the DVD RAM disk in packets. When the stop recording command is received, the final five to six seconds of data in the history buffer is transferred to the DVD disk and recording on the disk is stopped. Data continues to accumulate in the history buffer after recording stops.

If external power is removed from the system while recording, an internal battery (not shown) continues to provide power to the system to permit the contents of the buffer to be stored on the DVD disk before shutting down the system. The internal battery may, for example, provide a minimum of three minutes of backup power.

The tray logic board includes an eight-bit microprocessor, which is responsive to commands received from the overhead console to control the DVD RAM drive 50. Commands from the console include all the standard commands of a DVD player. The tray logic board, vertical board, connector board, video server board and the DVD RAM drive 50 are all enclosed in the locked protective steel vault 30. The vault 30 is insulated and resistant to damage. The temperature inside the vault 30 is controlled using a solid state heat pump and air circulation fans (not shown). The heat pump and fans are controlled by a temperature sensor, which senses the ambient temperature inside the steel vault 30. The tray logic board activates the heat pump to heat or cool the inside of the vault 30 to maintain its internal temperature between approximately 50° F. and 100° F. independent of the ambient external temperatures.

Five, seven and one-half and nine and one-half hour recording times are available on a DVD-RAM disk, subject to the resolution selected (GOOD, BETTER, or BEST). DVD disks may be reviewed on the in-car monitor 16. DVD disks are available through Kustom Signals, or can be purchased locally through any electronics store. Preferably, name brand, high quality Type II DVD disks should be used. Low quality DVD disks can shorten the life of the recorder 50.

The DVD RAM drive 50 has several advantages over VHS and digital tapes used in prior art in-car video systems. For example, at the same resolution as a VHS tape in SP mode, the DVD RAM drive 50 may record up to eight hours of video data on a single-sided, single-layer DVD disk 52. DVD disks may be single-sided or double-sided. Double-sided disks hold two-times as much data as a single-sided disk. Thus, a double-sided disk may hold the equivalent of two VHS tapes. DVD disks are much more durable than a VHS or digital tape, require less storage space, are less susceptible to damage by magnetic sources and are not worn by repeated playing. With the DVD disk 52, each incident captured may be indexed for on-screen selection and immediately accessed without having to rewind or fast-forward as is required by a tape. An incident may be watched over and over again instantly.

The system may include a watermark applied to the DVD disk 52 to ensure that any attempt at tampering with the original video is easily detectable. Watermarks are bits of digital information woven throughout the entire stream of a digital video. DVD recording and playing devices automatically prevent unauthorized recording and playback of unauthorized copies by means of Copy Control Information (CCI) detected in the digital video content. For example in a one-second stream of video, which has an average size of one megabit per second, a watermark would be about two bytes of data. Because the watermark is part of the video itself, it may not be removed without damaging the video image. In this manner, evidence recorded on a DVD RAM disk 52 using a watermark cannot be tampered with without being detected.

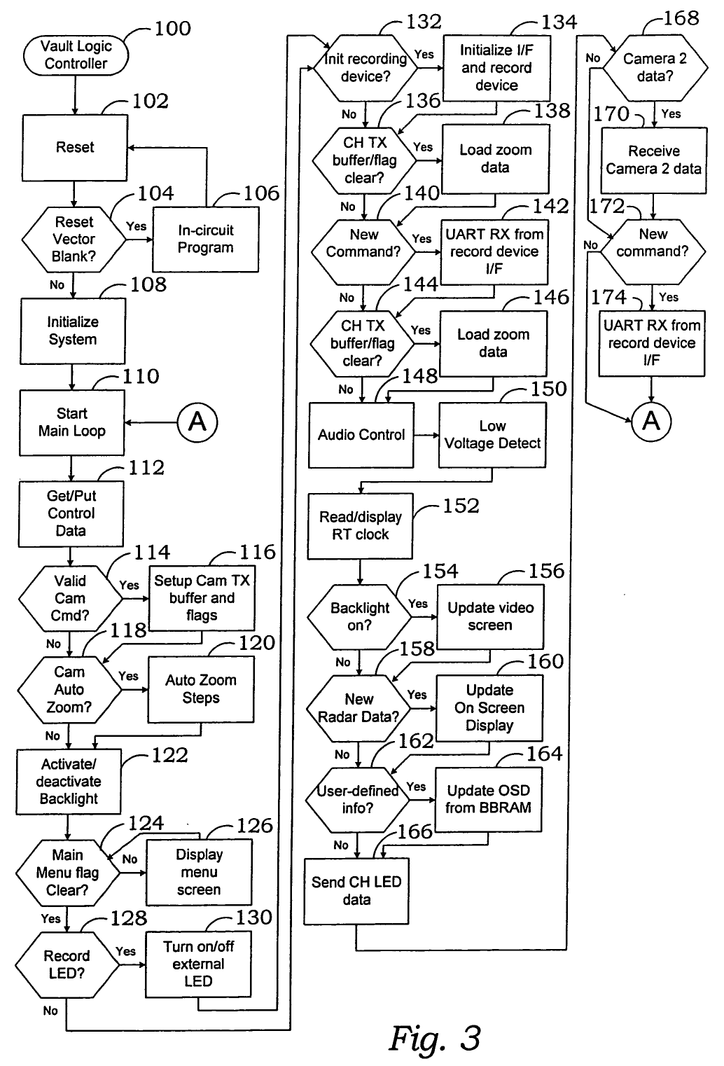

Operation of the vault logic will first be discussed with reference to the vault logic controller routine 100 shown in FIG. 3. The vault logic controller routine 100 begins with a system reset as indicated in block 102. In decision block 104, the microprocessor first inquires if the reset vector is blank. If the reset vector is blank, in-circuit programming 106 of the microprocessor is initiated and the I/O pins of the microprocessor are configured to connect the internal UART to the diagnostic/programming port. Once in-circuit programming is complete, control returns to the reset block 102. If the reset vectors are present, the vault logic processor proceeds to initialize the system as indicated in block 108.

The initialization routine at system power-up indicated in block 108 includes initializing the vault logic microprocessor 10 port pins, the phase lock loop, the asynchronous serial ports also referred to as the serial communication interface (SCI), initializing the serial peripheral interface (SPI), the A-D converter, keyboard interrupt and port pins. The vault logic microprocessor RAM is set to zero, the external input devices are initialized, the radar buffer is cleared and ports are initialized along with the internal clock chip. The on-screen display chips are initialized. The transfer rate and other configuration data are sent to the SPI UART and this information is verified to be correctly set. The battery backed RAM is initialized. The vault logic microprocessor will then proceed to turn on the power relays for the control head and drive power. Default flags are set for camera 12, in-car microphone in the off-state, and setting the wireless microphone 38 to a desired frequency. The vault logic microprocessor also verifies communication between the removable digital storage media and the control head logic.

After the system is initialized, the vault logic microprocessor begins executing the main loop of the software as indicated by block 110. The main loop runs continuously, checking flags and interrupts to service whatever condition may occur or to react to whatever user input that may occur. To keep the system reacting in near real-time, functions that require more than a few milliseconds to complete will do a portion of the task and then return to the main loop to allow another function to be addressed. This is accomplished by the use of flags and other data that represent function steps. One example of this is the auto-zoom function that must wait on the camera to zoom, activate auto-focus, pause for a few seconds, and then return to the wide zoom position. This also serves to reduce the required depth of the stack for each function.

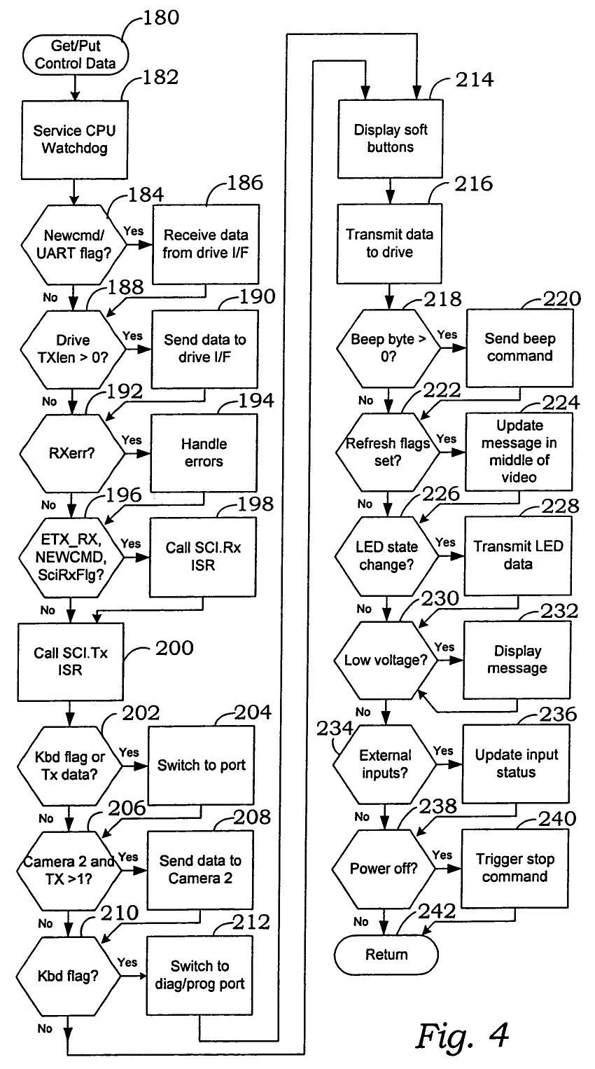

At the beginning of the main loop the Get/Put Control Data routine is called as indicated by block 112. The Get/Put Control Data routine is a group of command and control routines, which are discussed with reference to the flow diagram shown in FIG. 4. Next the vault logic microprocessor inquires, decision block 114, if a valid camera command byte is present. If a valid camera command byte is present then the vault logic microprocessor sets up the camera transmit buffer and associated flags, as indicated by block 116. If auto-zoom for a second camera 14 or 42 is active, decision block 118, the vault logic microprocessor steps through the stages of auto-zoom as indicated by block 120. After each individual step of auto-zoom is completed, the system returns to the main loop and continues processing. Auto-zoom is activated by depressing an auto button (not shown) on the overhead console. When this button is pressed, the color cameras lens will zoom to a telephoto position, pause, perform a momentary auto focus, then retract to a wide-angle position. Ideally, when the lens pauses, or somewhere within the travel of zoom, the scene should include a sharp legible license plate image. The auto-zoom feature is also useful at night to zoom in on a reflective license plate. In the wide-angle position, reflective license plates are unlikely to be legible. By zooming in, the camera can react to the bright reflection and produce a readable license plate number.

Next, the vault logic microprocessor determines if the backlight needs to be activated or deactivated 122. The back light compensation feature improves the quality of recordings when the camera is facing into the sunrise or sunset or any bright light. When facing a bright light, the camera reacts to the predominantly bright scene and closes its iris. This results in the subjects in front of the bright light to be too dark. The vault logic microprocessor compensates for a bright light source in back of the main subject and opens the camera's iris.

The vault logic microprocessor next processes the main menu routine. If the main menu flag is set by the keyboard interrupt routine, described hereinbelow, as indicated by decision block 124, the main menu screen is displayed as indicated by block 126. Processing remains in the main menu routine until the main menu flag is cleared. This displays the initial menu screen and subsequent submenus are called from this main routine. Each of the subsequent menus return to the main menu routine. The main menu routine also calls the Get/Put Control Data routine (described hereinbelow) to access the command and control features of the system.

After the main menu flag is cleared, the vault logic microprocessor will inquire as to the status of the record LED, decision block 128. If the record state of the system has changed, the vault logic microprocessor sets or resets a flag to turn on or turn off an external LED, block 130. The LED record indicator, which may be positioned on the camera 12, provides confirmation to the officer when outside the vehicle that the system is recording and the microphone is being received. When the system is recording, the record indicator light will come on and remain steady. This light will blink if, while recording, the system receives a transmission from the wireless microphone.

If the initialize recording device flag is cleared by the video server, decision block 132, the DVD ram disk 52 is initialized along with its interface, block 134. If the control head transmit buffer is empty and the control head initialization flag is clear, decision block 136, zoom data parameters are loaded in the control head transfer buffer, block 138. If the new command flag is set, for example by the keyboard interrupt routine, decision block 140, by the transmit interrupt routine, the logic microprocessor takes actions based upon data received from the record device interface, block 142.

If the control head transfer buffer is empty and the control head initialization flag is clear, decision block 144, the zoom data is loaded into the control head transfer buffer 146. Periodically, the vault logic microprocessor sets the audio left and right channel playback gates and in-car microphone gate, block 148. The system includes two audio channels, one for the in car microphone, and the other for the wireless microphone. If the in car mic is turned on, the speakers are muted if a signal is received on the wireless mic.

Next, the system enables the A-D converter routine to measure the low-voltage input, block 150. If the system voltage drops to approximately 10.5 volts, a low volt detect routine sets the flag to turn on the low voltage LED. Low voltages will also place the system in its stop mode. If the power is removed from the system altogether rather than dropping below the 10.5-volt threshold, the state of the system will be preserved and will be automatically restored once power is returned.

Based upon the output from the real-time clock chip, the vault logic microprocessor reads and displays the real-time clock, block 152. If the back light function in block 122 has been activated, decision block 154, the video screen is updated, block 156, to display the back light icon.

If new radar data is available (see accessories 40, FIG. 2), decision block 158, the on-screen display radar area is updated, block 160. If user-defined information, such as officer name, badge number, etc., is present, decision block 162, the on-screen display is updated from the data in the battery-backed RAM, block 164. Periodically, the vault logic microprocessor sends LED status data to the control head, block 166. Next, if camera 14 or 42 data is available decision block 168, the data is received and sent to the recording device block 170. The system again checks for any new commands block 172 and responds accordingly 174. Processing then returns to the main loop block 110.

Referring to FIG. 4, the Get/Put Control Data flow chart is illustrated. The Get/Put Control Data routine is called by several routines including the main loop and the various menu routines. It performs the communication and control routines for the system. When the Get/Put Control Data routine 180 is called, the CPU watchdog is serviced, block 182. If the CPU watchdog is not periodically serviced, the watchdog process will detect a system error and reset the system.

If the new command and UART transfer flags are set by the Receive Interrupt Service Routine, decision block 184, the vault logic microprocessor receives data from the drive interface, block 186, and takes action based upon the data received. If the drive data transfer length is greater than zero, decision block 188, data is sent to the drive interface via the serial peripheral interface (SPI) UART, block 190. If the receive error flag is set by the drive interface, decision block 192, a flag is set by the Timer ISR and the data resent, block 194. If the new command byte, serial communication interface, receive flag and ETX_RX flag are set, decision block 196, a check sum is performed to verify the accuracy of the data and then the system branches to port specific data handling, block 198. The system will send an acknowledge byte (ACK) indicating that the data was properly received or not-acknowledge byte (NACK) indicating that the data was not properly received based upon the flags that are set, block 200. After the serial transfer flag is set, the system will enable the SCI transfer empty interrupt to send the data to the control head utilizing the on-board UART.

If the control head keyboard interrupt flag is set or transfer data is present in the control head transfer buffer, decision block 202, the transfer port is prohibited from switching until the transfer or receive is complete, block 204.

Next, if the system is switched to camera 14 or 42 and the transfer step is greater than the pre-determined value, decision block 206, control data is transferred to camera 14 or 42, block 208. Next, if the keyboard interrupt flag is set by the Keyboard ISR, decision block 210, the vault logic microprocessor will switch the internal UART to the diagnostic/programming connection, block 212. The system will remain in the diagnostic/programming function until diagnostics are completed or programming is completed.

The display buttons routine, block 214, displays the soft button labels on the video screen 16 based on the level byte received from the control head. The soft button labels are software defined and controlled labels to display system setup and control information. Based on the command byte data, the vault logic microprocessor will transmit the proper data based on the menu or control selection to the recording device interface via the SPI UART, block 216.

The beep byte defines the number of status beeps the system emits. Normally the beep byte is set to zero. If the beep byte is greater than zero, decision block 218, the beep command and number of beeps is transmitted to the control head 10, block 220. Whenever the system starts to record the beep function is activated and the system beeps three times, for example. The system may beep eight times whenever the recording media is nearly full, when there is a low voltage condition or when the temperature inside the vault or recorder's enclosure is out of the operating temperature range.

User-defined or system messages may be displayed in the middle or bottom of the display screen 16. If either the refresh message 1 or refresh message 2 flags are set, decision block 222, the message displayed in the middle of the recorded video is updated, block 224. If the LED state has changed, decision block 226, the current control head data will be transmitted to the control head from the vault logic microprocessor, block 228. Next, if a low-voltage condition was detected in block 150, decision block 230, a low-voltage message will be placed on the video and the system will remain in the low voltage processing condition until the voltage returns to an acceptable level, block 232.

Periodically, the vault logic microprocessor examines the external inputs such as the siren, lights, auxiliary video one, brake and microphone inputs, decision block 234, and sets flags to reflect their status to be displayed on the video, block 236. When a power off input is received, decision block 238, the switch is debounced and a stop command is sent to the recording device, block 240. When the recording device has stopped, the power is turned off. Control then returns to the main routine, block 242.

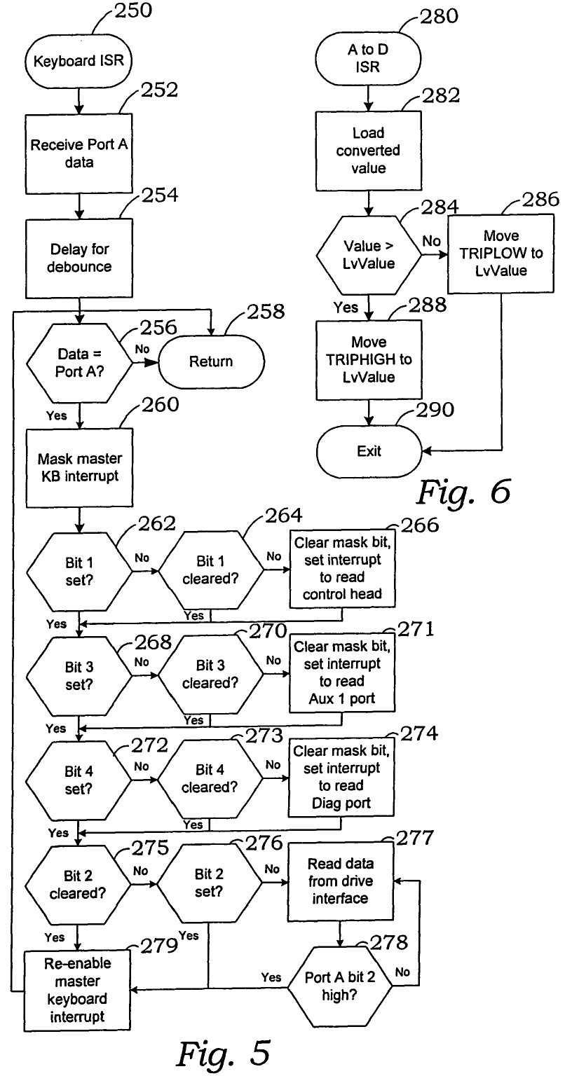

Referring to FIG. 5, the flow chart for the keyboard interrupt service routine 250 is shown and begins by receiving port A data, block 252, delaying for debounce, block 254, then checking the data read in block 252 with the port A data, decision block 256. If the data is not equal, the routine exits, block 258. If the data is equal, the keyboard interrupt is masked, block 260. If bit 1 is not set, decision block 262, and has not been cleared, decision block 264, the mask bit is cleared, and the interrupt is set to read control head data, block 266. Next if 3 is not set, decision block 268, and bit 3 has not been cleared, decision block 270, the mask bit is cleared and the AUX 1 port interrupt is set, block 271. Next if bit 4 is not set, decision block 272, and has not been cleared, decision block 273, the mask bit is cleared and the diagnostic port interrupt is set, block 374. If bit 2 has not been cleared, decision block 275, and has not been set, decision block 276, data is read from the drive interface, block 277. If port A bit 2 is returned high, decision block 278, the master keyboard interrupt is re-enabled, block 279, and the routine returns, block 258.

The flow chart for the analog to digital interrupt service routine 280, which monitors system voltage levels, is shown in FIG. 6. The analog to digital interrupt service routine 280 begins by loading the converted value 282 then comparing it to the upper and lower limits, decision block 284. If the converted value is less than the lower limit (triplow), then triplow is moved to the low voltage (LV) value, block 286, and the interrupt returns 290. If the value is greater than the LV value (triphigh), then triphigh value is moved to LV value, block 288 and the interrupt service routine exits 290.

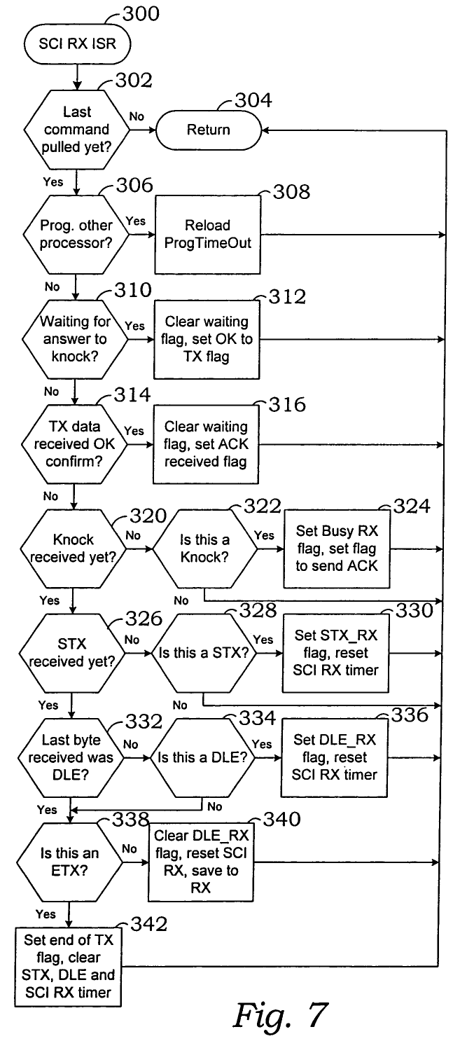

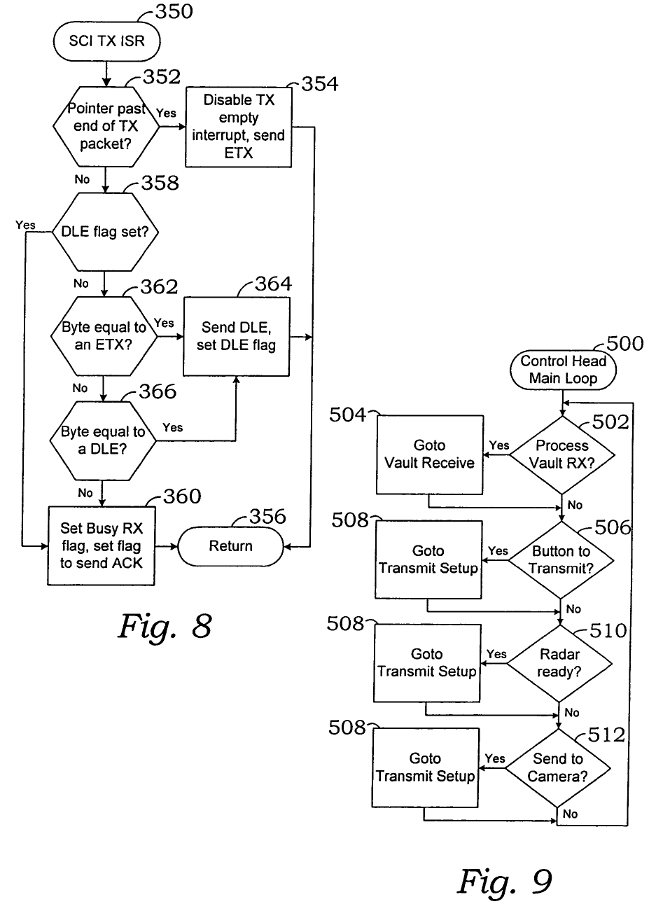

Referring to FIGS. 7 and 8, the SCI RX and SCI TX routines are called by the main loop to send or receive serial transmissions from the main processor to the Control Head, Aux port, or Diagnostic port, for example, when they are needed. The port is determined based on the Keyboard ISR. The Motorola processor used allows auto receiving and transmitting of data.

The SCI RX routine 300 begins by determining if the last command has been pulled yet, decision block 302. If it has not, the SCI RX routine returns, block 304. If the last command has been pulled, the system determines if another processor is being programmed, decision block 306. If yes, the program time out is reloaded, block 308, and the routine returns, block 306. If another processor is not being programmed, the system determines if an answer to a command-interrogate “knock,” decision block 310. If waiting for a knock, the waiting flag is cleared, the TX flag is set, block 312, and the routine exits, block 304.

If not waiting to answer a knock, the system determines transmitted data was received correctly, decision block 314. If the transmitted data has been correctly received, the waiting flag is cleared and the ACK received flag is set, block 316, and the routine returns, block 304. If the system is not waiting to confirm data received, the routine checks if a knock has been received, decision block 320. If a knock has not been received yet, the current data is checked to determine if it is a knock, decision block 322. If it is not, the routine exits, block 304. If it is, the receive busy flag is set and the send ACK flag is set, block 324, and the routine exits, block 304.

If a knock has been received, the serial transmit (STX) is determined, block 326. If an STX has not been received, the routine determines if the current data is a STX, decision block 328. If it is, the serial transmit/receive flag is set and the serial receive timer is reset, block 330, and the routine exits, block 304. If the last byte received is not the Dynamic Link Escape (DLE) byte, decision block 332, then the current byte is checked. If the current byte is the DLE byte, decision block 334, the DLE receive flag and serial receive timer are reset, block 336, and the routine returns, block 304. If the last byte received is the DLE, the system determines if this is the end of transmission (ETX), decision block 338. If it is not, the DLE_RX flag is cleared, the serial receive timer is reset and the data is saved to the receive buffer, block 340. If this is the end of transmit, the end of transmit flag is set, the serial transmit, DLE and serial receive timers are reset, block 342, and the routine exits, 304.

The DLE byte is an ASCII 16 or Hex 10. This byte is used to receive the next character that is being sent in a transmission on its numerical value only if that character normally might have special significance. For example, a Hex 03 means ETX in normal communications. Thus, if a Hex 03 is sent in a data stream and it does not mean ETX, then the DLE byte is sent before the Hex 03 byte to ensure that the data is received and not misinterpreted as an ETX byte. For example, if the data to be sent is “02 05 A5 03 F6 B0 03,” then the following would be sent to ensure that all the data is properly received “02 05 A5 10 03 F6 B0 03.”

The Serial Transmit interrupt service routine 350 begins by determining if a pointer used to keep track of data transmission progress is past the end of the transmit packet, decision block 352. If it is, the transmit empty interrupt is disabled and an end of transmit is sent, block 354, and the routine exits, block 356. If the pointer is not past the end, the DLE flag is checked, decision block 358. If the DLE flag is set, the next data byte is sent, and the transmit pointer is incremented, block 360, and the routine exits, block 356. If the DLE flag is not set, the routine determines if this is an end of transmit byte, decision block 362. If it is, the DLE is sent, the DLE flag is set, block 364, and the routine returns, block 356. If it is not, the routine determines if the byte is equal to the DLE, decision block 366. If it is, he DLE is sent, the DLE flag is set, block 364, and the routine returns, block 356. If it is not, the next data byte is sent, the transmit pointer is incremented, block 360, and the routine exits, block 356.

Referring to FIGS. 9-18, the software flow charts for the Control Head microprocessor are shown. It should be understood that the software flow charts illustrate the operation of the Control Head microprocessor, but are not intended to be construed as a literal translation of the code for the Control Head. As with many microprocessor based systems, execution of some routines is interrupt driven, other routines are executed based on a time slice, others may be sequentially processed, while still other routines are concurrently processed. Additionally, the source code language may influence the processing structure. The software flow charts provide one means to disclose the software control of the Control Head microprocessor and are not intended to be limited to the form presented.

Referring to FIG. 9, the Control Head Main Loop is illustrated, block 500. The Control Head Main Loop runs repeatedly until the system is reset. Initially, the Control Head Main Loop determines if video or other data has been received from the vault, decision block 502. If data has been received, the Vault Receive routine is called, block 504. If no data has been received from the vault, decision block 502, the control head microprocessor determines if any of the control buttons have been depressed, block 506. If a button has been pressed, the Transmit Setup routine is called, block 508, processes the data, and returns to the next step. If no buttons have been pressed, decision block 506, the control head microprocessor determines if the radar data is ready to transmit data, decision block 510. If the radar data is ready, the Transmit Setup routine is called, block 508, processes the data, and returns to the next step. If no radar data is ready, decision block 510, the control head microprocessor next determines if there is camera data ready to send, decision block 512. If camera data is ready, the Transmit Setup routine is called, block 508, processes the data, and returns to the next step. Processing returns to the start of the Control Head Main Loop and repeats.

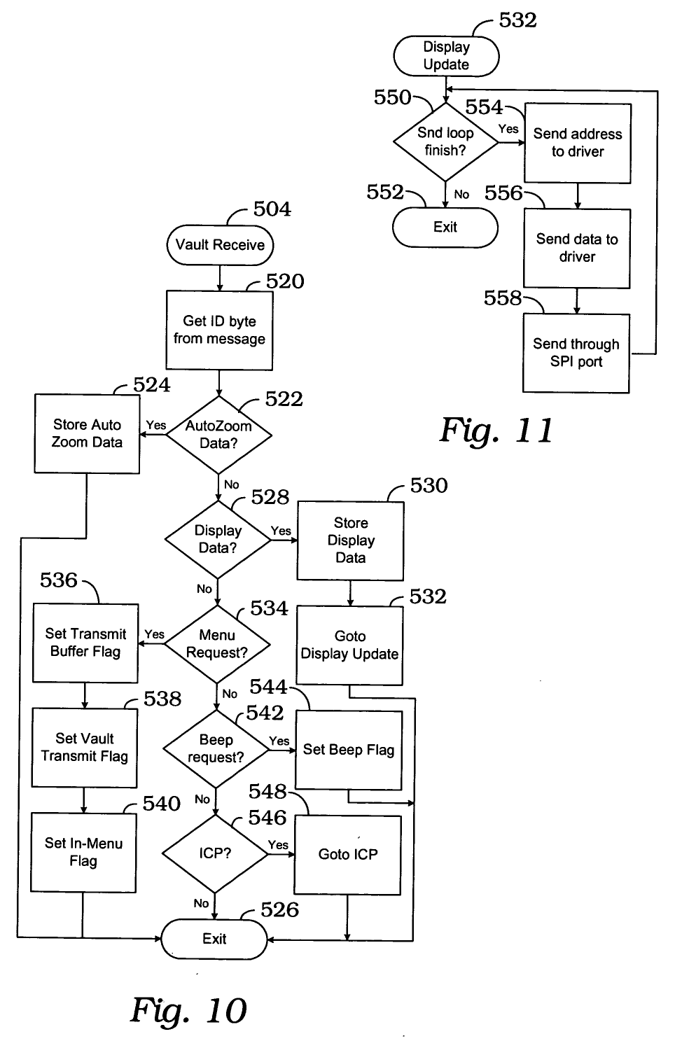

Referring to FIG. 10, the Vault Receive routine flow chart is illustrated beginning with block 504. First, the identification byte, which identifies the source and type of data being passed, from the input message is determined, block 520. If the ID byte indicates that the data is auto zoom data, decision block 522, the auto zoom data is stored, block 524 and the Vault Receive routine returns to the Control Head Main Loop, block 526. If the ID byte indicates display data, decision block 528, the display data is stored, block 530, and the Display Update routine is called, block 532. Upon return from the Display Update routine, the Vault Receive routine returns to the Control Head Main Loop, block 526.

If the ID byte is a menu request, decision block 534, the transmit buffer flag is set, block 536, the vault transmit flag is set, block 538, and the in-menu flag is set, block 540. These flags are read by other processes and the appropriate action taken. Processing returns to the Control Head Main Loop, block 526.

If the ID byte is a beep request, decision block 542, the beep flag is set, block 544, and control returns to the Control Head Main Loop, block 526. If the ID byte is a in-circuit programming (ICP) request, decision block 546, the ICP routine is called, block 548.

Referring to FIG. 11, the Display Update routine, which was called by the Vault Receive routine (FIG. 10), begins, block 532, by determining if the send loop has finished, decision block 550. If all the display data has not been sent, the Display Update routine exits, block 552. If all display data has been sent by the vault, the address is sent to the display driver, block 554, the display data is sent to the display drive, block 556, and the data is sent to the SPI port, block 558, to the display. Processing returns to the beginning to process the next available display data.

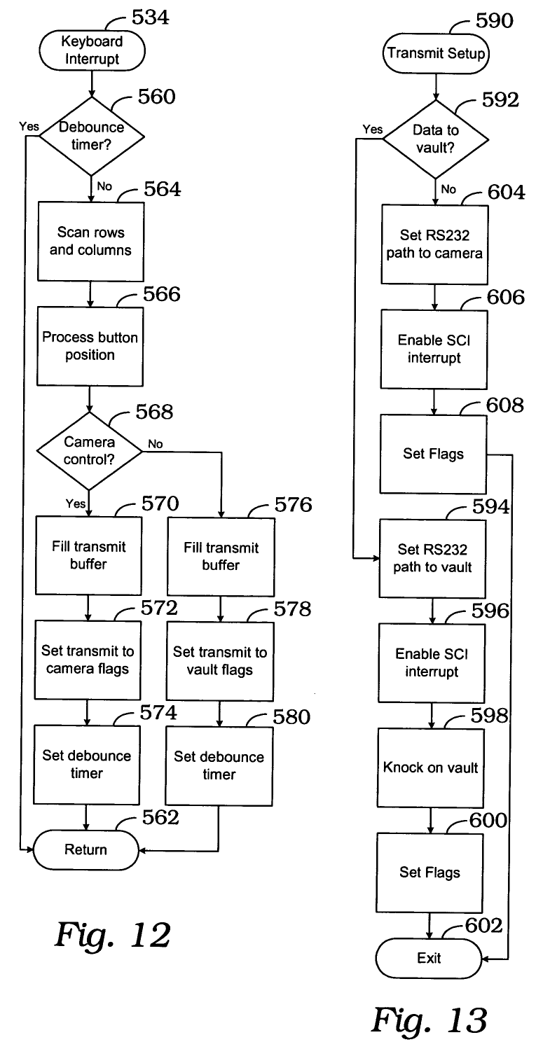

Referring to FIG. 12, Keyboard Interrupt routine, block 534, begins by determining if the debounce timer is running, decision block 560. The debounce timer is used to ignore additional or repeating inputs until the first input is processed. If the debounce timer is running, the routine exits, block 562. If the debounce timer is not running, the rows and columns of the keyboard matrix are scanned, block 564, and the button position is determined, block 566. If the button pressed is related to camera control, decision block 568, camera data is loaded in the transmit buffer, block 570, the transmit to camera flags are set, block 572, and the debounce timer is reset, block 574. If the key pressed is not related to camera control, the data is loaded into the transmit buffer, block 576, the transmit to vault flags are set, block 578, and the debounce timer is started again, block 580.

Referring to FIG. 13, the Transmit Setup routine is shown starting with block 590. If the data in the transmit buffer is to be sent to the vault as indicated by the transmit to vault flags, decision block 592, the serial path to the vault is set, block 594, the SCI interrupt is enabled, block 596, and a knock is sent to the vault, block 600. Next, flags are set to indicate the source of the data to be sent to the vault, block 600, and the routine exits, block 602. If the data is not to be sent to the vault, decision block 592, the serial path to the camera is set, block 604, the SCI interrupt is enabled, block 606, and the flags are set to indicate the source of the data to be sent to the camera, block 608. The routine then exits, block 602.

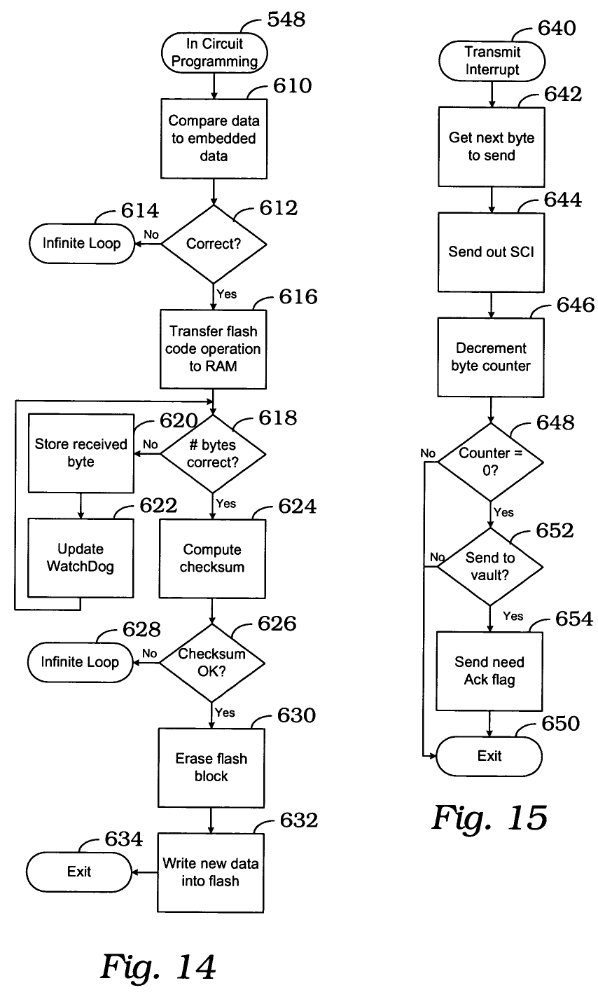

Referring to FIG. 14, The In-circuit Programming interrupt routine starting with block 548 is shown. The data from the diagnostic/programming port is compared to the embedded data to determine if reprogramming of the system is proper, decision block 612. If the data does not match, the system locks-up in an infinite loop, block 614, until the watch dog timer times out. If the data matches, the flash code is transferred from the diagnostic/programming port to control head RAM, block 616. The user vectors are erased, block 615. If the correct number of bytes have not been received, decision block 618, the received data is stored, block 620, the watchdog timer is updated, 622, and another byte of data is checked. If the correct number of bytes have been received, decision block 624, a checksum of the data is calculated, block 624, to determine if the data was correctly received. If the checksum calculated does not match the checksum received, decision block 626, the system locks-up in an infinite loop, block 628, until the watch dog timer times out. If the checksum is correct, decision block 626, the flash memory is erased, block 630, the newly received program is written to flash memory, block 632, and the ICP interrupt exits, 634.

Referring to FIG. 15, the Transmit interrupt routine, block 640, begins by getting the next byte of data to send, block 642. The data is transmitted through the SCI, block 644, and the counter is decremented, block 646. If the counter is not zero, which indicates that all data has been sent, decision block 648, the Transmit Interrupt exits, block 650. If all data has been sent as indicated by the counter equaling zero, decision block 648, a flag is checked to determine if the data was sent to the vault, decision block 652. If no data was sent to the vault, the Transmit Interrupt exits, block 650. If data was sent to the vault, decision block 652, the need acknowledgement flag is set, block 654 and the interrupt exits, block 650.

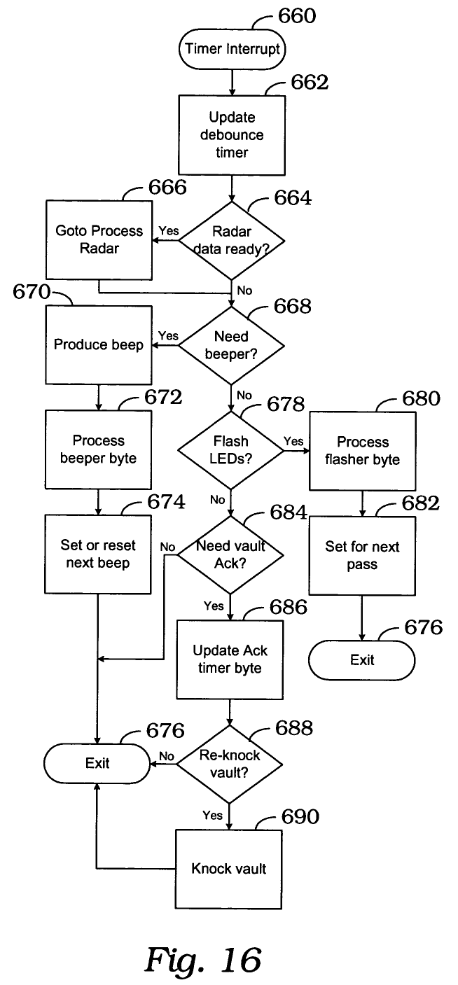

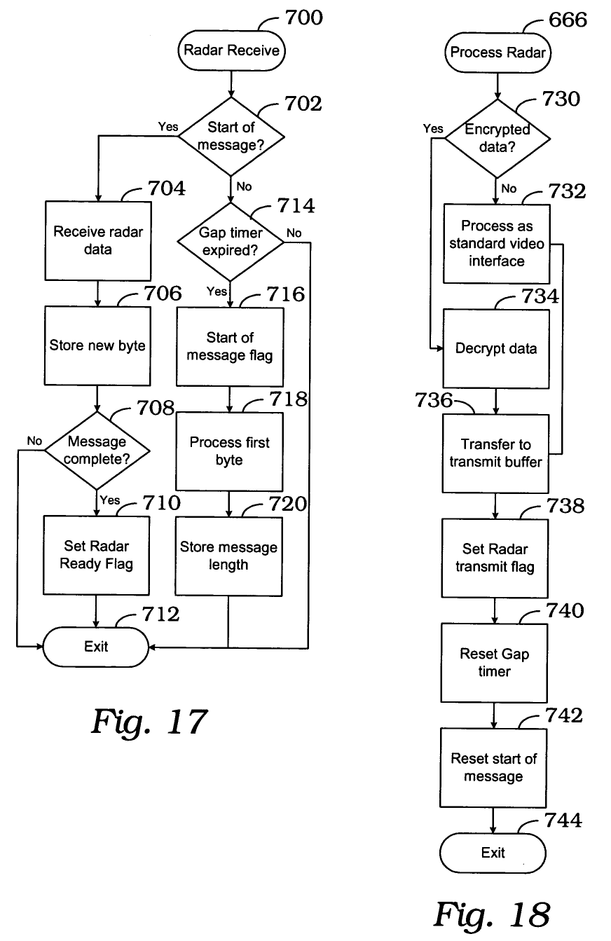

Referring to FIG. 16, the Timer Interrupt starting with block 660 is illustrated. The Timer Interrupt is enabled approximately 256 times per second by an internal clock to service timers and interrupt flags set by other routines. First, the debounce timer is updated, block 662, then the Timer Interrupt reads the radar ready flag to determine if the radar data is ready to send, decision block 664. If radar data is ready, the Process Radar routine is called (see FIG. 17). Next the Timer Interrupt routine reads the beeper flag. If a status beep is needed, decision block 668, a beep is output, block 670, the beeper byte is processed to determine what type of beep, block 672, and the next beep is set or reset, block 674. The Timer Interrupt routine then exits, block 676.

If no beeper is needed, decision block 668, the Timer Interrupt routine reads the Flash LEDs flags. If the LEDs need to be flashed, decision block 678, the flasher byte is processed, block 680, the flasher byte is set for the next pass through this routine, block 682, and the routine exits, block 676. If no LED needs to be flashed, the Timer Interrupt routine examines the vault acknowledge flag. If no acknowledgement is needed from the vault, decision block 684, the routine exits. If acknowledgement is need from the vault, decision block 684, the acknowledgement timer is updated, block 686. If an acknowledgement is required from the vault and has been received before the acknowledgement timer has expired, the vault does not need to be re-knocked, decision block 688, and the interrupt exits, block 676. If the acknowledgement timer has expired and the vault has not sent an acknowledgement, the vault needs to be re-knocked, decision block 688, the vault is sent another knock, decision block 690, and the interrupt exits.

The Radar Receive Interrupt routine is shown in FIG. 17 starting with block 700. If it is the start of a radar message, decision block 702, the radar data is receive, block 704, and stored, block 706. If the message is not complete, decision block 708, the interrupt routine exits, block 712. If the message is complete, the radar ready flag is set, block 710, and the interrupt exits, block 712. If it is not the start of a radar message, decision block 702, and the gap timer has not expired, decision block 714, the routine exits, block 712. If gap timer has expired, decision block 714, the start of radar message flag is set, block 716, the first byte of the message is processed to determine the message length, block 718, and the message length is stored, block 720. The interrupt routine then exits, block 712.

The Process Radar routine is shown in FIG. 18 beginning with block 666. If the data received from the radar is not encrypted, decision block 730, the data is processed as standard video data, block 732, and then transferred to the transmit buffer, block 736. If the data is encrypted, decision block 730, the data is first decrypted, block 734, then sent to the transmit buffer, block 736. Next the radar transfer flag is set, block 738, the gap timer is reset, block 740, and the start of message flag is reset, block 742. The Process Radar routine then exits.

### System Set-Up

Referring to FIG. 19, the dynamic button labels generally indicated by reference numeral 800 are normally not displayed on the monitor 16. The main menu labels 800 are automatically displayed on the monitor 16 when any of the monitor buttons generally indicated by reference numeral 802 are pressed. The main menu includes the option labels Play, Zoom, Focus, Setup and Exit located on the monitor 16 above the dynamic buttons 802.

Depressing the button 804 under the SETUP selection provides access to the Setup Menu 806 (FIG. 20). The system may be configured to restrict access to the setup menu. The DVD disk 52 should be in the recorder 50 to enter some parts of the setup menu system. The system records any changes made in the setup routine that impact recording to later determine if the recording on the DVD disk 52 has been altered. A quick review of the recording will either verify the time was not changed, or prove that it was changed.

The setup menu 806 allows the following options to be easily selected or changed: Time/Date; T/D Position; Flash Preference; Date Format; ID Generator; Daylight Savings Adjustment; Auto Zoom Settings; Record Length; Playback rate (Skiprate); Beep Tone Enable; Audio Out Select; and Eject Enable.

When the SETUP button is depressed (FIG. 19), the dynamic button labels 800 are reassigned to the following functions as shown in FIG. 20: up arrow 812, down arrow 814, and EXIT. The EXIT button 808 is relabeled as the ENTER button as the cursor 810 is positioned or scroll up the menu 806 using the arrow buttons 812 and 814, in order to make a selection.

From the Setup Menu 806, selection of Time/Date/User Text 816 displays the submenu Display Menu generally indicated by reference numeral 818 as shown in FIG. 21. The monitor's dynamic buttons 802 are assigned up arrow, down arrow, and ENTER.

Using the arrow buttons 812 and 814, the cursor 810 may be positioned next to the Set Time/Date menu label 820 and the Enter button 822 pressed to access the Set Time/Date submenu generally indicated by reference numeral 824, FIG. 22. This option allows the user to set the time and date that is recorded onto the DVD disk 52. The system's calendar includes provisions for leap years, and can be set to automatically adjust for daylight saving time. To set the Hour, Minute, Month, Day and Year values, a cursor 828 is moved over the digit to be changed using the left and right arrow buttons 830 and 832 respectively. Once the cursor is placed over the digit to be changed and the up and down arrow buttons 812 and 814 may be used to increase or decrease the value. To set the value, the ENTER button 822 is pressed and the system returns to the Display Menu 818, FIG. 21.

The User Information option 834 allows the operator to add an identifier to the video recordings. Examples include: officer badge number, car number, precinct number, etc. Three lines of 20 spaces each generally indicated by reference numeral 836, FIG. 23, may be used. A cursor 838 may be moved over a character position to be changed using the left and right buttons 830 and 832, and may be changed using the up and down arrow buttons 812 814 to scroll through the alphabet, digits and other characters. Pressing the EXIT w/SAV button 840 saves the information entered and returns to the Display Menu 818.

The Position option 842 allows the operator to place the time and date at the top or bottom of the screen 16. Using the up and down arrow buttons 812 and 814 to move the cursor 810 next to the Position option 842, the position of the time and date may be toggled between bottom of the screen and top of the screen by pressing the ENTER button 822.

The Flash preference 844 allows the operator to select whether or not the time and date will flash. Flashing the time and date (every 12 second for example) allows objects behind the time and date to be seen intermittently. Using the up and down arrow buttons 812 and 814 to move the cursor 810 next to the Flash option 844, flashing of the time and date may be toggled between ON (time and date flashes on screen) and OFF (time and date do not flash) by pressing the ENTER button 822.

The Date Format 846 allows the operator to set how the date is displayed. Using the up and down arrow buttons 812 and 814 to move the cursor 810 next to the Format option 846, the format of the date may be toggled between MM/DD/YY and DD/MM/YY by pressing the ENTER button 822.

The Daylight Savings Mode option 848 allows the operator to control automatic time adjustment for daylight savings. Using the up and down arrow buttons 812 and 814 to move the cursor 810 next to the Daylight Sav option 848, automatic adjustment of the time may be toggled between ON (system will automatically adjust for daylight savings) and OFF (system will not automatically adjust for daylight savings) by pressing the ENTER button 822.

Selecting Exit 850 on the Display Menu 818 will return the system to the Setup Menu display 806 (FIG. 20).

The System Settings option 852 allows the operator to set the recording quality and file name of the saved recording. Using the up and down arrow buttons 812 and 814 to move the cursor 810 next to the System Settings option 852 and the ENTER button 808 pressed to access the System Settings menu generally indicated by reference numeral 854, FIG. 24.

Selection of the Record Quality option 856 allows the operator to utilize different recording resolutions and therefore different recording time length. The GOOD setting provides 9 Hrs and 20 minutes of record time; the BETTER setting provides 7 Hrs and 30 minutes of record time and the BEST setting provides 5 Hrs and 20 minutes of record time. The record length may be changed at any time. If this setting is changed in the middle of a DVD disk recording, the time-left display will change accordingly.

Selection of the Filename option 858 allows the operator to change the file name of the recorded file on the DVD disk 52.

Referring to FIG. 20, selection of the Auto Zoom option 860 displays the Set Zoom Values menu generally indicated by reference numeral 862, FIG. 25, and allows the operator to customize the values used for the auto zoom feature described hereinabove. The Tele and Wide values are percentages and may be changed by positioning the cursor 810 next to the value to be changed and using the up and down arrows 812 and 814 to adjust the value. Selecting the Restore defaults option 868 resets the Tele and Wide values to predetermined values. Selecting the Exit w/Save option 870 and pressing the EXIT button 872 saves the values and returns the display to the Setup Menu, FIG. 20.

The Beep option 874 allows the operator to select whether audible alert (beep tones) messages are output through speaker 18. If this feature is ON, three beeps, for example, will be output whenever the system starts to record. Whenever the DVD disk 52 is almost full or there is a low voltage condition detected by the system, eight beeps, for example, will be output.

The Audio Out option 876 is used when the system is equipped with an optional in-car microphone. Audio Out allows the operator to select which audio sources will be played back over the in-car monitor 16. For example, the in-car microphone may be recorded while simultaneously conducting interviews outside the patrol vehicle with the wireless microphone 38. The system is equipped with a DVD recorder 50 with two audio tracks. The two microphone sources are recorded on separate tracks and for playback, this menu option allows the operator to easily isolate the track of interest.

The Software Versions option 878 allows the operator to view the software revisions for each of the micro-controllers for diagnostic purposes.

The Allow EJECT option 880 allows the operator to eject the DVD disk 52. The eject button (not shown) on the DVD drive 50 is disabled during normal operation in order to ensure that the disk is write-protected when it is removed. In this manner, evidence cannot be accidentally erased from the disk when it is removed from the system. The Allow EJECT selection 880 write-protects the disk, and enables the Eject button on the front of the DVD drive 50.

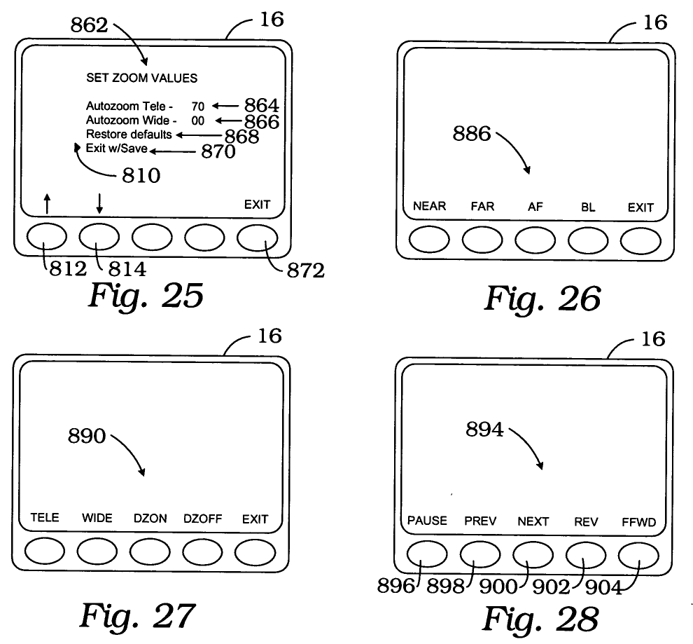

Selection of Exit 882 returns the system display to the Main Menu, FIG. 19. Referring to FIGS. 19 and 26, selection of the FOCUS button 884 displays the Focus menu generally indicated by reference numeral 886. The FOCUS menu 886 allows the user to utilize manual focus functions (NEAR, FAR), activate or disable Autofocus (AF), and activate or disable the Backlight (BL) functions.

Referring to FIGS. 19 and 27, selection of the ZOOM button 888 displays the Zoom menu generally indicated by reference numeral 890. The ZOOM menu 890 allows the operator to utilize manual zoom functions (TELE, WIDE), and to activate or disable Digital Zoom (DZON, DZOFF).

Referring to FIGS. 19 and 28, selection of the PLAY button 892 displays the Play menu generally indicated by reference numeral 894. The PLAY menu 894 allows the user to utilize the system's video playback functions, perform Fast-Forward or Reverse Searches and Pause the video at any time. When the Play menu 894 is initially displayed from the Main Menu, the system automatically plays the last recorded video file.

While in the Play menu 894, and during the process of playing back the last recorded video file, the operator may select any of the functions displayed on the PLAY menu 894. Video playback may be paused by pushing the PAUSE menu key 896. Previously recorded video clips may be viewed by pushing the PREV (Previous) button 898. This button may be pushed to “scroll back” through previously recorded video files as many times as the operator desires until the beginning of the disk recording is reached. Each time the PREV button 898 is pressed, the file previous to the one currently showing will be played back. This button may be pushed until the first file recorded on the disk is reached. At that point the PREV button 898 will no longer elicit a response from the system, and the first file will play.

When viewing previously recorded video segments, the operator may move forward in the video segments as well, playing back video recorded after the one currently being viewed. This is accomplished by pressing the NEXT button 900. Each time the NEXT button 900 is pressed, the file recorded after the one currently being viewed is played back. The NEXT button 900 may be pushed until the operator has reached the last video segment recorded, at which time that segment will play.

To reverse search the current video segment being viewed, the operator may press the REV (reverse) button 902. Likewise, the operator may forward search the current video segment being viewed by depressing the FFWD (fast forward) button 904.

### System Operation

When the system is turned ON, a single audible beep is output on speaker 18. If the system has been exposed to extreme temperatures for an extended period of time, 20-30 minutes of ignition operation may be required for the environmental system to bring the interior of the enclosure to within the recorder's operating temperature range (necessary to record). If the temperature is above freezing, recording can begin immediately.

When a blank DVD disk 52 is inserted into the recorder 50, the control center 10 displays the time remaining on the disk 52. If no disk 52 is in recorder 50, the Control Center 10 displays three horizontal lines, for example.

The system may automatically start recording when the emergency lights or siren is turned on, or when the wireless microphone 38 is activated.

When the system is turned on, a single beep is output from the Control Center 10 through speaker 18. Beeps are provided (if activated) to indicate whenever the system receives a record command, when the DVD disk 52 nears its end or when a low voltage condition exists. These beeps are intended to alert the operator to the status of the system without having to look at the Control Center 10 or monitor 16. For example, when the emergency lights are turned on, the system will automatically initiate the record command. The Control Center 10 will beep three times to confirm that the system recognized the lights and has activated the record command.

Having thus described the invention, what is claimed as new and desired to be secured by Letters Patent is as follows:

1. A digital video surveillance system for a law enforcement vehicle comprising:
a video camera for generating video signals of an incident, said video camera mounted on said law enforcement vehicle and positioned to view an incident;
a memory buffer for recording said video signals from said video camera;
a controller for selectively generating record and playback signals to record and to display said video signals; and
a digital video recorder responsive to said record signal to record said video signals from said memory buffer on an optical medium, said video recorder responsive to said playback signal to reproduce video signals recorded on said optical medium.

2. The digital video surveillance system as set forth in claim 1 further comprising a vault enclosing said digital video recorder.

3. The digital video surveillance system as set forth in claim 1 further comprising a display selectively responsive to said video signals generated by said video camera and said video signals reproduced by said digital video recorder to display a video image.

4. The digital video surveillance system as set forth in claim 1 further comprising a battery for providing backup power to said digital video surveillance system.

5. The digital video surveillance system as set forth in claim 1 wherein said optical medium is a DVD disk.

6. The digital video surveillance system as set forth in claim 5 further comprising means for combining digital information with said video signals prior to recording on said optical medium to provide a tamper-resistant digital recording.

7. The digital video surveillance system as set forth in claim 6 wherein said digital information is a watermark.

8. The digital video surveillance system as set forth in claim 1 further comprising:
a wireless microphone for generating a radio signal modulated by received audio communications;
a receiver responsive to said radio signal for generating electrical signals corresponding to said audio communications received from said wireless microphone; and
logic circuitry for combining said video signals and said electrical signals into a composite signal;
said memory buffer being responsive to said composite signal to continuously record said composite signal;
said video recorder recording said composite signal on said optical medium in response to receiving said record signal and reproducing said composite signal recorded on said optical medium in response to receiving said playback signal.

9. The digital video surveillance system as set forth in claim 8 further comprising a speaker mounted on said law enforcement vehicle responsive to said electrical signals generated by said receiver and said electrical signals of said composite signal reproduced by said digital video recorder.

10. The digital video surveillance system as set forth in claim 1 further comprising a console mounted on said law enforcement vehicle having user-operable controls coupled to said controller for directing the operation of said system.

11. The digital video surveillance system as set forth in claim 10 wherein said console includes a display responsive to said video signals generated by said video camera and said video signals reproduced by said digital video recorder to display a video image.

12. A digital video incident capture system for a law enforcement vehicle comprising:
a video camera for generating video signals of an incident, said video camera mounted on said law enforcement vehicle and positioned to view said incident;
a wireless microphone adapted to be worn by an operator of said law enforcement vehicle, said wireless microphone generating a radio signal modulated by received audio communications;
a receiver responsive to said radio signal for generating electrical signals corresponding to said audio communications received from said wireless microphone;
a controller for selectively generating record and playback signals to record and playback said video signals and said electrical signals corresponding to said audio communications;
logic circuitry for combining said video signals and said electrical signals into a composite signal;
a memory buffer for continuously storing said composite signal;
a digital video recorder having a DVD drive and responsive to said record signal from said controller to record said composite signal from said memory buffer on a DVD disk, said recorder responsive to said playback signal to reproduce said composite signal recorded on said DVD disk;
a display selectively responsive to said video signals generated by said video camera and said video signals of said composite signal reproduced by said digital video recorder to display a video image; and
a speaker mounted in said law enforcement vehicle responsive to said electrical signals generated by said receiver and said electrical signals of said composite signal reproduced by said digital video recorder.

13. The digital video surveillance system as set forth in claim 12 further comprising a vault enclosing said digital video recorder.

14. The digital video incident capture system as set forth in claim 12 further comprising a battery for providing backup power to said digital video incident capture system.

15. The digital video incident capture system as set forth in claim 14 further comprising means for combining digital information said video signals prior to recording on said DVD disk to provide a tamper-resistant digital recording.

16. The digital video incident capture system as set forth in claim 15 wherein said digital information is a watermark.

17. The digital video incident capture system as set forth in claim 12 further comprising a console mounted on said law enforcement vehicle having user-operable controls coupled to said controller for directing the operation of said system.

18. The digital video incident capture system as set forth in claim 17 wherein said display is mounted in said console.

19. A digital video surveillance system for a law enforcement vehicle comprising:
a video camera for generating video signals, said video camera being mounted on said law enforcement vehicle and positioned to view an incident;
a history buffer for continuously recording said video signals from said video camera to provide a video history of predetermined duration;
a controller for selectively generating a record signal and a playback signal;
a digital video recorder having a disk drive and responsive to said record signal for receiving and recording said video history on an optical medium and for receiving and recording ensuing video signals from said history buffer, and responsive to said playback signal for reproducing video signals recorded on said medium; and
a display selectively responsive to said video signals from the video camera and said video signals reproduced by said video recorder for displaying a video image.

20. The digital video surveillance system as set forth in claim 19 further comprising a vault enclosing said digital video recorder.

21. The digital video surveillance system as set forth in claim 19, wherein said optical medium is a DVD disk.

22. The digital video surveillance system as set forth in claim 19 further comprising a battery for providing backup power to said digital video surveillance system.

23. The digital video surveillance system as set forth in claim 19 further comprising means for combining digital information with said video signals prior to recording on said optical medium to provide a tamper-resistant digital recording.

24. The digital video surveillance system as set forth in claim 23 wherein said digital information is a watermark.

25. The digital video surveillance system as set forth in claim 19 further comprising:
a wireless microphone adapted to be worn by an operator of said law enforcement vehicle, said wireless microphone generating a radio signal modulated by received audio communications;
a receiver responsive to said radio signal for generating electrical signals corresponding to said audio communications received from said wireless microphone; and
logic circuitry for combining said video signals and said electrical signals into a composite signal;
whereby said memory buffer continuously records said composite signal and said video recorder records said composite signal on said optical medium in response to receiving said record signal and reproduces said composite signal recorded on said optical medium in response to receiving said playback signal.

26. The digital video surveillance system as set forth in claim 25 further comprising a speaker mounted on said law enforcement vehicle responsive to said electrical signals generated by said receiver and said electrical signals of said composite signal reproduced by said digital video recorder.

27. The digital video surveillance system as claimed in claim 25, wherein said digital optical medium is a DVD disk.

28. The digital video surveillance system as set forth in claim 25 further comprising means for combining digital information with said video signals prior to recording on said optical medium to provide a tamper-resistant digital recording.

29. The digital video surveillance system as set forth in claim 28 wherein said digital information is a watermark.

30. The digital video surveillance system as set forth in claim 19 further comprising a console mounted on said law enforcement vehicle having user-operable controls coupled to said controller for directing the operation of said system.

31. The digital video surveillance system as set forth in claim 30 wherein said console includes a video display responsive to said video signals generated by said video camera and said video signals reproduced by said digital video recorder.
